(19) United States
(12) Patent Application Publication
(10) Pub. No.: US 2020/0202138 A1
(43) Pub. Date: Jun. 25, 2020

(54) ADVERTISEMENT DELIVERY USING AUDIENCE GROUPING AND IMAGE OBJECT RECOGNITION

(71) Applicant: International Business Machines Corporation, ARMONK, NY (US)

(72) Inventors: JANANI JANAKIRAMAN, AUSTIN, TX (US); FANG LU, BILLERICA, MA (US); NADIYA KOCHURA, BOLTON, MA (US); SU LIU, AUSTIN, TX (US)

(21) Appl. No.: 16/226,114

(22) Filed: Dec. 19, 2018

(51) Int. Cl. G06K 9/00; G06K 9/62; G06Q 30/02

(52) U.S. Cl. CPC G06K 9/00778; G06Q 30/0267; G06Q 30/0245; G06K 9/628

(57) ABSTRACT

Advertisement delivery using audience grouping and image object recognition may include: receiving image data; identifying, based on the image data, a plurality of image objects associated with a plurality of persons; generating, from the plurality of persons and based on the plurality of image objects, a plurality of clusters, each of the plurality of clusters comprising one or more persons of the plurality of persons; determining a classification for a cluster of the plurality of clusters; determining an advertisement associated with the classification; and sending the advertisement to an advertising platform based on a location of the cluster.

### BACKGROUND

### Field of the Invention

The field of the invention is data processing, or, more specifically, methods, apparatus, and products for advertisement delivery using audience grouping and image object recognition.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Advertisers may use public displays such as smart bulletin boards or electronic displays to present advertisements. It may be difficult to target advertisements to a particular audience.

### SUMMARY

Advertisement delivery using audience grouping and image object recognition may include: receiving image data; identifying, based on the image data, a plurality of image objects associated with a plurality of persons; generating, from the plurality of persons and based on the plurality of image objects, a plurality of clusters, each of the plurality of clusters comprising one or more persons of the plurality of persons; determining a classification for a cluster of the plurality of clusters; determining an advertisement associated with the classification; and sending the advertisement to an advertising platform based on a location of the cluster.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a diagram of an example system for advertisement delivery using audience grouping and image object recognition.

FIG. 2 is a block diagram of an example computer for advertisement delivery using audience grouping and image object recognition.

FIG. 3 is a flowchart of an example method for advertisement delivery using audience grouping and image object recognition.

FIG. 4 is a flowchart of an example method for advertisement delivery using audience grouping and image object recognition.

FIG. 5 is a flowchart of an example method for advertisement delivery using audience grouping and image object recognition.

FIG. 6 is a flowchart of an example method for advertisement delivery using audience grouping and image object recognition.

FIG. 7 is a flowchart of an example method for advertisement delivery using audience grouping and image object recognition.

### DETAILED DESCRIPTION

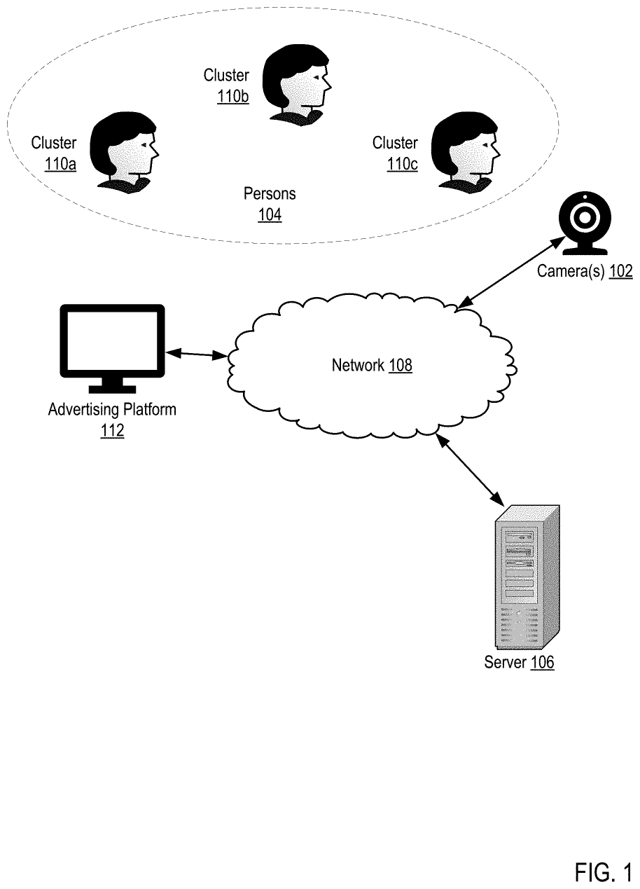

Exemplary methods, apparatus, and products for advertisement delivery using audience grouping an image object recognition in accordance with the present invention are described with reference to the accompanying drawings, beginning with FIG. 1. FIG. 1 sets forth a network diagram of a system configured for advertisement delivery using audience grouping according to embodiments of the present invention. The system of FIG. 1 includes one or more cameras 102. The one or more cameras 102 may be disposed at a variety of locations within a particular premises. The one or more cameras 102 are configured to capture image data (e.g., one or more still images, video data) depicting one or more persons 104. As an example, the cameras 102 may be disposed at a variety of locations within a shopping mall or airport, and the cameras 102 are configured to capture image data of patrons. As another example, the cameras 102 may be disposed at a variety of locations along a public area (e.g., a sidewalk or intersection) and the cameras 102 are configured to capture image data of pedestrians.

The image data captured by the cameras 102 is received by a server 106 via a network 108. The cameras 102 may each be configured with a direct connection to the network 108 (e.g., a wired or wireless connection) and may accordingly communicate directly with the server 106. The cameras 102 may also be connected to an intermediary server or other computing device that aggregates the image data for sending to the server 106. The network 108 may comprise one or more Local Area Networks (LANs), Wide Area Networks (WANs), Personal Area Networks, mesh networks, cellular networks, internets, intranets, or other networks and combinations thereof. The network 108 may comprise one or more wired connections, wireless connections, or combinations thereof.

After receiving the image data, the server 106 identifies a plurality of image objects associated with the plurality of persons. Identifying the plurality of image objects may comprise processing the image data using a trained classifier, such as a neural network (e.g., a convolutional neural network (CNN) or deep learning neural network), an untrained classifier, or other machine learning model or computer vision algorithm. Identifying the plurality of image objects may include identifying a plurality of person image objects (e.g., image objects corresponding to a particular person 104) and a plurality of component image objects of the plurality of person image objects (e.g., image objects within a particular person image objects). For example, a person image object may correspond to a particular person 104, while a component image object for that person 104 may include individual articles of clothing, detectable logos, a face, held physical objects, etc. Thus, the plurality of image objects may comprise both person image objects and associated component image objects.

The server 106 may then generate a plurality of clusters 110a,b,c from the persons 104 such that each cluster 110a,b,c, indicates one or more persons 104. Generating the plurality of clusters 110a,b,c serves to identify persons 104 likely to be associated with a same group, demographic, or other targetable audience. Generating the plurality of clusters 110a,b,c may comprise applying a clustering algorithm (e.g., k-means clustering or another clustering algorithm) to each person 104 based on a plurality of attributes based on their associated image objects. Such attributes can include a worn color or pattern, worn styles of clothing, a worn logo, a held object, etc. Accordingly, clusters 110a,b,c may be generated such that persons 104 having similar attributes are grouped into a same cluster 110a,b,c. For example, persons 104 wearing a same sports team logo or color scheme are likely to be part of the same group.

Additional attributes may also be derived from the image data to generate the plurality of clusters 110a,b,c. A proximity between persons 104 (e.g., a distance between person image objects) may be used as an attribute to generate clusters 110a,b,c. For example, persons 104 close together are likely to be part of the same group, and therefore part of the same cluster 110a,b,c. As another example, image data captured over time can indicate a movement direction of persons 104 based on a change in position of their respective person image objects. Persons 104 moving in the same direction are more likely to be part of the same group, and therefore more likely to be included in the same cluster 110a,b,c. As a further example, the cameras 102 may also capture audio data. Language or keyword detection may be applied to the audio data to determine that persons 104 are speaking the same language or discussing a same topic, thereby increasing the likelihood that they should be included in the same cluster 110a,b,c.

Moreover, attributes used in generating the clusters 110a,b,c may be derived from metadata associated with particular image objects. For example, image objects for a particular article of clothing or held item may be associated with a particular retail price. The retail prices of worn or held items may be used to calculate an estimated income bracket. The estimated income bracket may then be used as an attribute for generating the clusters 110a,b,c.

After generating the clusters 110a,b,c, a classification of one or more of the clusters 110a,b,c may be determined. A classification may be determined for each of the clusters 110a,b,c, or for one or more clusters 110a,b,c, selected from the plurality of clusters 110a,b,c. Determining a classification for a particular cluster 110a,b,c may comprise applying a classifier to one or more classification attributes of the particular cluster 110a,b,c. The classifier may then determine a classification of a plurality of predefined classifications for the particular cluster 110a,b,c.

The classification attributes used to classify a particular cluster 110a,b,c may comprise those attributes used to generate the clusters 110a,b,c (e.g, attributes associated with the plurality of image objects associated with the particular cluster 110a,b,c). For example, the classification attributes may include visible logos, color schemes, types of clothing, held objects, movement direction, etc. The classification attributes may also include attributes associated with audio data (e.g., spoken languages, topics of discussion, etc.). The classification attributes may also include a number of persons 104 in the particular cluster 110a,b,c or a location of the particular cluster 110a,b,c (e.g., latitude and longitude, or within a predefined boundary or geofence).

A given classification attribute may not be applicable to all persons 104 in the particular cluster 110a,b,c. For example, each person 104 in a particular cluster 110a,b,c may be wearing different colors, but are nonetheless clustered together due to similarities in other attributes (e.g., movement direction, proximity, type of clothing). The classification attributes for a particular cluster 110a,b,c may reflect all values for a particular classification attribute reflected in the particular cluster 110a,b,c. For example, assume a cluster 110a,b,c includes persons wearing suits, dresses, and gym clothing. The cluster 110a,b,c may then be classified using the “clothing type” attribute for each value “suits,” “dresses,” and “gym clothing.”

The classifier may weigh each value of a particular classification attribute according to a degree to which it is reflected in the cluster 110a,b,c. For example, assuming that a majority of persons 104 in a cluster 110a,b,c are wearing suits, the classifier may weigh the “suits” value for the “clothing type” attribute higher than other values. The classifier may also filter values for classification attributes. For example, again assuming that persons 104 in a cluster 110a,b,c are wearing either suits, dresses, or gym clothing, the classifier may only classify the cluster 110a,b,c based on the clothing type value applicable to the majority of persons 104 in the cluster 110a,b,c.

Determining the classification for a cluster 110a,b,c may comprise selecting a data structure entry from a plurality of data structure entries each corresponding to a respective classification. For example, the plurality of data structure entries may each indicate a respective plurality of classification attributes. Each data structure entry may also comprise one or more relevant topics for the particular category. Determining the classification for a cluster 110a,b,c may comprise selecting, from the plurality of data structure entries, a data structure based on a degree of similarity (e.g., cosine similarity) between the classification attributes of the data structure and the classification attributes of the cluster 110a,b,c.

The server 106 may select a cluster 110a,b,c for targeting with an advertisement. Selecting a cluster 110a,b,c may be performed based on a number of persons 104 in the cluster 110a,b,c (e.g, selecting a cluster 110a,b,c with the most persons 104). Selecting a cluster 110a,b,c may also be performed based on a movement speed or detectable facial expression of the persons 104 in the cluster 110a,b,c. For example, a fast-moving cluster 110a,b,c or a cluster 110a,b,c with persons 104 expressing irritation, anger, etc. may be less preferentially selected as the audience may be less receptive to advertisements at that time. Selecting a cluster 110a,b,c may also be performed based on whether the cluster 110a,b,c was classified in a predefined classification. For example, a classification may correspond to a demographic selected for preferential targeting. A cluster 110a,b,c that was classified into this classification may be preferentially selected.

One skilled in the art would understand that a combination of factors may be used and/or weighted in determining a cluster 110a,b,c for targeting. Additionally, one skilled in the art would appreciate that a cluster 110a,b,c may be selected before or after classification. For example, a cluster 110a,b,c may be selected for targeting before classification based on factors independent of the classification (e.g., a number of persons 104 in the cluster 110a,b,c, a movement direction or speed), and then subsequently classified. This approach saves on computational resources that would otherwise be used to classify clusters 110a,b,c that may not be ultimately selected for targeting. As another example, a cluster 110a,b,c may be selected after each of the clusters 110a,b,c have been classified such that the classification may be used as a factor in selecting a cluster 110a,b,c for targeting.

An advertisement associated with the classification may be determined (e.g, an advertisement associated with the classification of a cluster 110a,b,c selected for targeting) by the server 106. The classification may be associated with one or more topics of interest. The advertisement may be determined based at least in part on the associated one or more topics of interest. The advertisement may also be selected based on one or more business rules (e.g., predicted revenue, advertising placement fees, advertisement testing purposes, etc.). The advertisement may comprise one or more still images, audio, video, or other content as can be appreciated.

The determined advertisement may then be sent by the server 106 to an advertising platform 112. The advertising platform 112 may comprise a stationary or immobile advertising platform, such as an electronic billboard, an e-ink advertising display, etc. Sending the advertisement to the advertising platform 112 causes the advertising platform 112 to render and/or display the advertisement. The server 106 may instruct the advertising platform 112 until a predefined event occurs (e.g., as determined by the server 106 or the advertising platform 112).

For example, the server 106 may instruct the advertising platform 112 to display the advertisement for a predefined duration. As another example, the server 106 may instruct the advertising platform 112 to display the advertisement until the advertising platform 112 is out of a line of sight of the cluster 110a,b,c (e.g., as determined based on image data received from cameras 102).

Sending the advertisement to the advertising platform 112 may comprise determining an advertising platform 112 based at least on a location of the cluster 110a,b,c. Determining the advertising platform 112 may comprise determining an advertising platform 112 nearest to the cluster 110a,b,c. For example, predefined locations associated with the advertising platforms 112 can be compared to predefined locations of cameras 102 and/or predicted locations of the cluster 110a,b,c (e.g., based on triangulation using a plurality of cameras 102) to determine a nearest advertising platform 112.

Determining the advertising platform 112 may also be performed based on a direction of movement or line of sight of the cluster 110a,b,c. For example, a pool of advertising platforms 112 may be filtered so as to only include those advertising platforms 112 toward which the cluster 110a,b,c is moving, or those advertising platforms 112 that are within a line of sight of the cluster 110a,b,c (e.g., based on a movement direction and/or direction of facing indicated in the image objects). The advertising platform 112 may then be selected from the filtered pool of advertising platforms 112.

The server 106 may also send the advertisement to one or more mobile devices. For example, the advertisement may be sent to one or more mobile devices proximate to the advertising platform 112 based on a near-field communication link. The advertisement may also be sent to one or more mobile devices connected to a same network as the advertising platform 112, or connected to a same wireless access point as the advertising platform 112. Sending the advertisement to a mobile device may include sending the advertisement as a push notification, text message, email, or other message. Sending the advertisement to the mobile device may include embedding the advertisement as a popup or as embedded content in a web page accessed by the mobile device through a wireless network accessible to the server 106.

The server 106 may receive feedback associated with the presented advertisement. For example, the advertising platform 112 may include a touch screen interface or other user input device that allows a user to indicate whether they found the advertisement to be relevant, pleasing, etc. The server 106 may also receive feedback by determining feedback based on image data from the cameras 102 indicating actions of one or more persons 104 in the cluster 110a,b,c that was targeted. Movement speed may be used to indicate feedback. For example, a person 104 in the cluster 110a,b,c slowing down may indicate positive feedback, as the person 104 may have slowed down to view the advertisement. Conversely, a person 104 speeding up or not changing speed may indicate neutral or negative feedback.

Facial expressions or gestures captured as image objects can also indicate feedback. For example, a facial expression indicating pleasure (e.g., a smile or laugh) may indicate positive feedback, while a facial expression or gesture indicating displeasure (e.g., a scowl or shaking of the head) may indicate negative feedback. Additionally, a duration that a person 104 in the targeted cluster 110a,b,c looks at the advertising platform 112 may also indicate feedback. For example, a look duration satisfying a threshold may indicate positive feedback, while a look duration falling below a threshold may indicate negative feedback. To these ends, the advertising platform 112 may include cameras 102 so as to better capture image data showing the facial expressions, gestures, etc. of persons 104 in the targeted cluster 110a,b,c. This image data may then be sent to the server 106 for processing into image objects in order to determine the particular feedback.

Where the advertisement is sent to a mobile device, the server 106 may receive feedback in the form of an input to a web page or user interface displaying the advertisement. For example, a user may indicate whether an advertisement was relevant, subjectively good or bad, etc. Feedback may also comprise a duration that the advertisement was displayed or rendered by the mobile device. For example, a duration satisfying a threshold may indicate positive feedback, while a duration falling below a threshold may indicate negative feedback.

In response to receiving the feedback, the server 106 may modify one or more models. For example, the server 106 may modify a model used for generating the clusters 110a,b,c (e.g., a reinforced clustering model or a supervised learning clustering model). The server 106 may also modify a model used for classifying the clusters 110a,b,c (e.g., adjusting one or more parameters, weights, etc. of the classification model).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

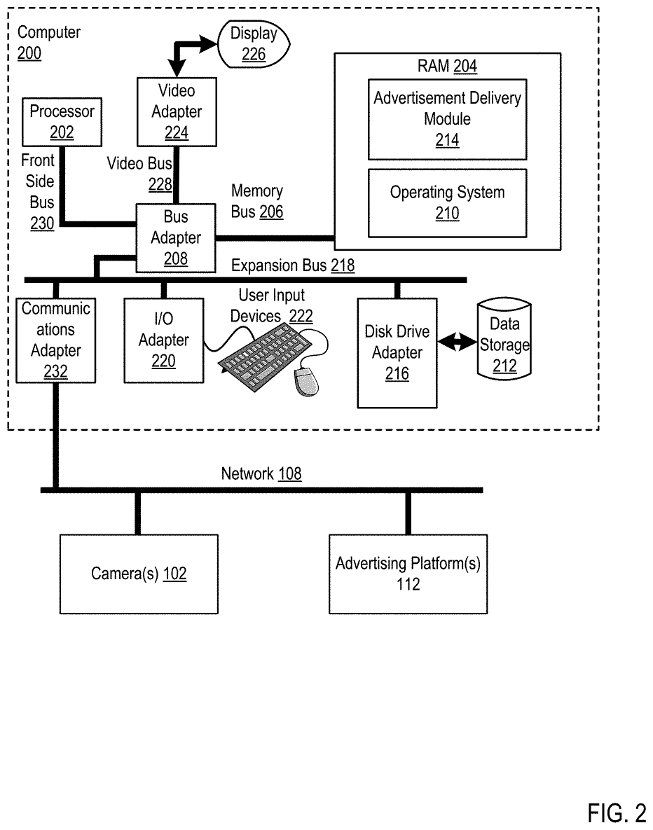

Advertisement delivery using audience grouping and image object recognition in accordance with the present invention is generally implemented with computers, that is, with automated computing machinery. In the system of FIG. 1, for example, all the server 106 and advertising platform 112 are implemented to some extent at least as computers. FIG. 2 sets forth a block diagram of automated computing machinery comprising an exemplary computer 200 configured for advertisement delivery using audience grouping and image object recognition according to embodiments of the present invention. The computer 200 of FIG. 2 includes at least one computer processor 202 or ‘CPU’ as well as random access memory 204 (RAM′) which is connected through a high speed memory bus 206 and bus adapter 208 to processor 202 and to other components of the computer 200.

Stored in RAM 204 is an operating system 210. Operating systems useful in computers configured for advertisement delivery using audience grouping and image object recognition according to embodiments of the present invention include UNIX™, Linux™, Microsoft Windows™, AIX™, IBM's i OS™, and others as will occur to those of skill in the art. The operating system 210 in the example of FIG. 2 is shown in RAM 204, but many components of such software typically are stored in non-volatile memory also, such as, for example, on data storage 212, such as a disk drive. Also stored in RAM 204 is the advertisement delivery module 214 a module for advertisement delivery using audience grouping and image object recognition according to embodiments of the present invention.

The computer 200 of FIG. 2 includes disk drive adapter 216 coupled through expansion bus 218 and bus adapter 208 to processor 202 and other components of the computer 200. Disk drive adapter 216 connects non-volatile data storage to the computer 200 in the form of data storage 212. Disk drive adapters useful in computers configured for advertisement delivery using audience grouping and image object recognition according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer 200 of FIG. 2 includes one or more input/output (I/O′) adapters 220. I/O adapters implement user-oriented input/output through, for example, software drivers and computer hardware for controlling output to display devices such as computer display screens, as well as user input from user input devices 222 such as keyboards and mice. The example computer 200 of FIG. 2 includes a video adapter 224, which is an example of an I/O adapter specially designed for graphic output to a display device 226 such as a display screen or computer monitor. Video adapter 224 is connected to processor 202 through a high speed video bus 228, bus adapter 208, and the front side bus 230, which is also a high speed bus.

The exemplary computer 200 of FIG. 2 includes a communications adapter 232 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for advertisement delivery using audience grouping and image object recognition according to embodiments of the present invention include modems for wired dial-up communications, Ethernet (IEEE 802.3) adapters for wired data communications, and 802.11 adapters for wireless data communications. The communications adapter 232 is communicatively coupled to a network 108 that also includes cameras 102 and advertising platforms 112.

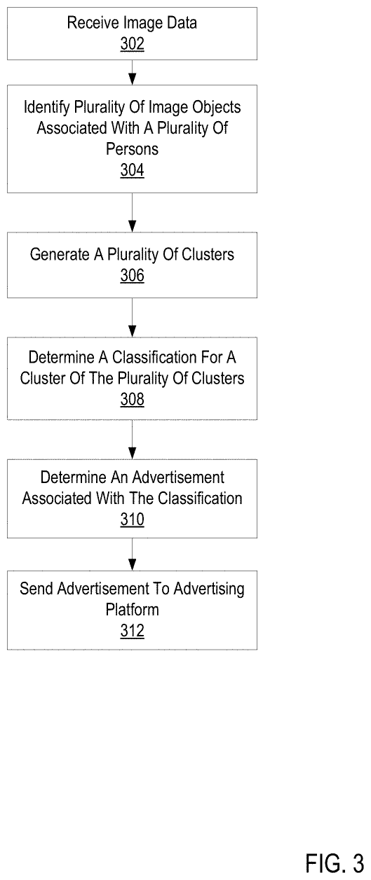

For further explanation, FIG. 3 sets forth a flow chart illustrating an exemplary method for advertisement delivery using audience grouping an image object recognition according to embodiments of the present invention that includes receiving 302 image data. Receiving image data may comprise receiving (e.g., by a server 106) image data from one or more cameras 102. The one or more cameras 102 may be disposed at a variety of locations within a premises. The image data may comprise one or more still images and/or video data depicting one or more persons 104.

The method of FIG. 3 may further comprise identifying 304 a plurality of image objects associated with the plurality of persons 104. Identifying the plurality of image objects may comprise processing the image data using a trained classifier, such as a neural network (e.g., a convolutional neural network (CNN) or deep learning neural network), an untrained classifier, or other machine learning model or computer vision algorithm. Identifying the plurality of image objects may include identifying a plurality of person image objects (e.g., image objects each corresponding to a particular person 104) and a plurality of component image objects of the plurality of person image objects (e.g., image objects within a particular person image objects). For example, a person image object may correspond to a particular person 104, while a component image object for that person 104 may include individual articles of clothing, detectable logos, a face, held physical objects, etc. Thus, the plurality of image objects may comprise both person image objects and associated component image objects, and a person 104 may be considered associated with both person image objects and component image objects.

The method of FIG. 3 may further comprise generating 306 a plurality of clusters 110a,b,c such that each cluster 110a,b,c, indicates one or more persons 104. Generating the plurality of clusters 110a,b,c serves to identify persons 104 likely to be associated with a same group, demographic, or other targetable audience. Generating the plurality of clusters 110a,b,c may comprise applying a clustering algorithm (e.g., k-means clustering or another clustering algorithm) to each person 104 based on a plurality of attributes based on their associated image objects. Such attributes can include a worn color or pattern, worn styles of clothing, a worn logo, a held object, etc. Accordingly, clusters 110a,b,c may be generated such that persons 104 having similar attributes are grouped into a same cluster 110a,b,c. For example, persons 104 wearing a same sports team logo or color scheme are likely to be part of the same group.

Generating the plurality of clusters 110a,b,c may also be based on additional attributes derived from the image data and/or image objects. A proximity between persons 104 (e.g., a distance between person image objects) may be used as an attribute to generate clusters 110a,b,c. For example, persons 104 close together (e.g., having proximate corresponding person image objects) are likely to be part of the same group, and therefore part of the same cluster 110a,b,c. As another example, image data captured over time can indicate a movement direction of persons 104 based on a change in position of their respective person image objects. Persons 104 moving in the same direction are more likely to be part of the same group, and therefore more likely to be included in the same cluster 110a,b,c. As a further example, the cameras 102 and/or other dedicated audio sensors may capture audio data. Language or keyword detection may be applied (e.g., by the server 106) to the audio data to determine that persons 104 are speaking the same language or discussing a same topic, thereby increasing the likelihood that they should be included in the same cluster 110a,b,c.

Moreover, attributes used in generating the clusters 110a,b,c may be derived from metadata associated with particular image objects. For example, image objects for a particular article of clothing or held item may be associated with a particular retail price. The retail prices of worn or held items may be used to calculate an estimated income bracket to be associated with a person 104. The estimated income bracket may then be used as an attribute for generating the clusters 110a,b,c.

The method of FIG. 3 may further comprise determining 308 classification of a cluster 110a,b,c. Determining a classification of a cluster 110a,b,c may comprise determining a respective classification for each of the determined clusters 110a,b,c. Determining the classification of a cluster 110a,b,c may also comprise determining a classification for a cluster 110a,b,c selected from the plurality of determined clusters 110a,b,c (e.g., based on a number of persons 104 in a cluster 110a,b,c, a location of the cluster 110a,b,c, etc.). Determining a classification for a cluster 110a,b,c may comprise applying a classifier to one or more classification attributes of the cluster 110a,b,c. The classifier may then determine a classification of a plurality of predefined classifications for the cluster 110a,b,c.

The classification attributes used to classify a cluster 110a,b,c may comprise those attributes used to generate the clusters 110a,b,c (e.g, attributes associated with the plurality of image objects associated with the particular cluster 110a,b,c). For example, the classification attributes may include visible logos, color schemes, types of clothing, held objects, movement direction, etc. The classification attributes may also include attributes associated with audio data (e.g., spoken languages, topics of discussion, etc.). The classification attributes may also include a number of persons 104 in the particular cluster 110a,b,c or a location of the particular cluster 110a,b,c (e.g., latitude and longitude, or within a predefined boundary or geofence).

A given classification attribute may not be applicable to all persons 104 in the cluster 110a,b,c. For example, each person 104 in the cluster 110a,b,c may be wearing different colors, but are nonetheless clustered together due to similarities in other attributes (e.g., movement direction, proximity, type of clothing). The classification attributes for the cluster 110a,b,c may reflect all values for a particular classification attribute reflected in the cluster 110a,b,c. For example, assume a cluster 110a,b,c includes persons wearing suits, dresses, and gym clothing. The cluster 110a,b,c may then be classified using each value “suits,” “dresses,” and “gym clothing” for the “clothing type” classification attribute.

Determining the classification for the cluster 110a,b,c may comprise weighing each value of a particular classification attribute according to a degree to which it is reflected in the cluster 110a,b,c. For example, assuming that a majority of persons 104 in a cluster 110a,b,c are wearing suits, the classifier may weigh the “suits” value for the “clothing type” attribute higher than other values. The classifier may also filter values for classification attributes. For example, again assuming that persons 104 in a cluster 110a,b,c are wearing either suits, dresses, or gym clothing, the classifier may only classify the cluster 110a,b,c based on the clothing type value applicable to the majority of persons 104 in the cluster 110a,b,c.

The method of FIG. 3 may also comprise determining 310 an advertisement associated with the classification (e.g., by the server 106). The classification may be associated with one or more topics of interest (e.g., as encoded by a data structure entry). The one or more topics of interest may comprise one or more keywords, one or more identifiers of a grouping or class of advertisements, or another value indicating that a particular topic may be relevant to the particular classification. Accordingly, determining the advertisement may comprise determining the advertisement based on the one or more topics of interest. For example, determining the advertisement may comprise determining the advertisement based on a matching or degree of similarity between the one or more topics of interest and one or more keywords associated with the advertisement. As another example, determining the advertisement may comprise selecting the advertisement from a grouping of advertisements identified by a topic of interest identifier. Determining the advertisement may also comprise determining the advertisement based on one or more business rules (e.g., predicted revenue, advertising placement fees, advertisement testing purposes, etc.). The advertisement may comprise one or more still images, audio, video, or other content as can be appreciated.

The method of FIG. 3 may further comprise sending 312 (e.g., by the server 106) the advertisement to an advertising platform 112. The advertising platform 112 comprises a device (e.g., a computing device) configured to render and/or display received advertising content. The advertising platform 112 may comprise a stationary or immobile advertising platform, such as an electronic billboard, an e-ink advertising display, etc. Sending the advertisement to the advertising platform 112 may comprise instructing the advertising platform 112 to display or render the advertisement until a predefined event occurs (e.g., as determined by the server 106 or the advertising platform 112). For example, the server 106 may instruct the advertising platform 112 to display the advertisement for a predefined duration. As another example, the server 106 may instruct the advertising platform 112 to display the advertisement until the advertising platform 112 is out of a line of sight of the cluster 110a,b,c (e.g., as determined based on image data received from cameras 102).

Sending the advertisement to the advertising platform 112 may comprise determining an advertising platform 112 based at least on a location of the cluster 110a,b,c. Determining the advertising platform 112 may comprise determining an advertising platform 112 nearest to the cluster 112. For example, predefined locations associated with the advertising platforms 112 can be compared to predefined locations of cameras 102 and/or predicted locations of the cluster 110a,b,c (e.g., based on triangulation using a plurality of cameras 102) to determine a nearest advertising platform 112.

Determining the advertising platform 112 may also be performed based on a direction of movement or line of sight of the cluster 110a,b,c. For example, a pool of advertising platforms 112 may be filtered so as to only include those advertising platforms 112 toward which the cluster 110a,b,c is moving, or those advertising platforms 112 that are within a line of sight of the cluster 110a,b,c (e.g., based on a movement direction and/or direction of facing indicated in the image objects). The advertising platform 112 may then be selected from the filtered pool of advertising platforms 112.

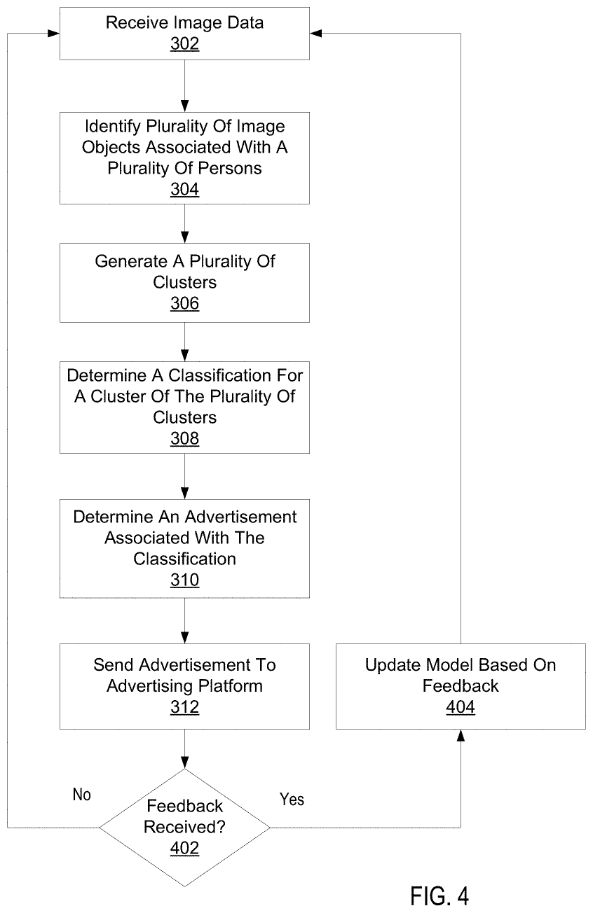

For further explanation, FIG. 4 sets forth a flow chart illustrating an exemplary method for advertisement delivery using audience grouping an image object recognition according to embodiments of the present invention that includes receiving 302 image data; identifying 304 a plurality of image objects associated with a plurality of persons 104; generating 306 a plurality of clusters 110a,b,c; determining 308 a classification for a cluster 110a,b,c of the plurality of clusters 110a,b,c; determining 310 an advertisement associated with the classification; and sending 312 the advertisement to an advertising platform 112.

FIG. 4 differs from FIG. 3 in that the method of FIG. 4 may further include determining 402 if feedback is received (e.g., by the server 106). The server 106 may receive feedback associated with the advertisement. For example, the advertising platform 112 may include a touch screen interface or other user input device that allows a user to indicate whether they found the advertisement to be relevant, pleasing, etc. The server 106 may also receive feedback by determining feedback based on image data from the cameras 102 indicating actions of one or more persons 104 in the cluster 110a,b,c that was targeted. Movement speed may be used to indicate feedback. For example, a person 104 in the cluster 110a,b,c slowing down may indicate positive feedback, as the person 104 may have slowed down to view the advertisement. Conversely, a person 104 speeding up or not changing speed may indicate neutral or negative feedback.

The server 106 may also receive feedback as facial expressions or gestures captured as image objects. For example, a facial expression indicating pleasure (e.g., a smile or laugh) may indicate positive feedback, while a facial expression or gesture indicating displeasure (e.g., a scowl or shaking of the head) may indicate negative feedback. Additionally, a duration that a person 104 in the targeted cluster 110a,b,c looks at the advertising platform 112 may also indicate feedback. For example, a look duration satisfying a threshold may indicate positive feedback, while a look duration falling below a threshold may indicate negative feedback. To these ends, the advertising platform 112 may include cameras 102 so as to better capture image data showing the facial expressions, gestures, etc. of persons 104 in the targeted cluster 110a,b,c. This image data may then be sent to the server 106 for processing into image objects in order to determine the particular feedback.

The method of FIG. 4 may return to receiving 302 image data if it is determined that no feedback is received (e.g., no feedback is received within a predefined duration and/or before another advertisement is sent to the advertising platform 112. The method of FIG. 4 may further include updating 404, if feedback was determined to be received, a model based on the received feedback. For example, the server 106 may modify a model used for generating the clusters 110a,b,c (e.g., a reinforced clustering model or a supervised learning clustering model). The server 106 may also modify a model used for classifying the clusters 110a,b,c (e.g., adjusting one or more parameters, weights, etc. of the classification model). After updating the model, the method of FIG. 4 may return to receiving 302 image data, whereinafter the method proceeds based on the updated model(s).

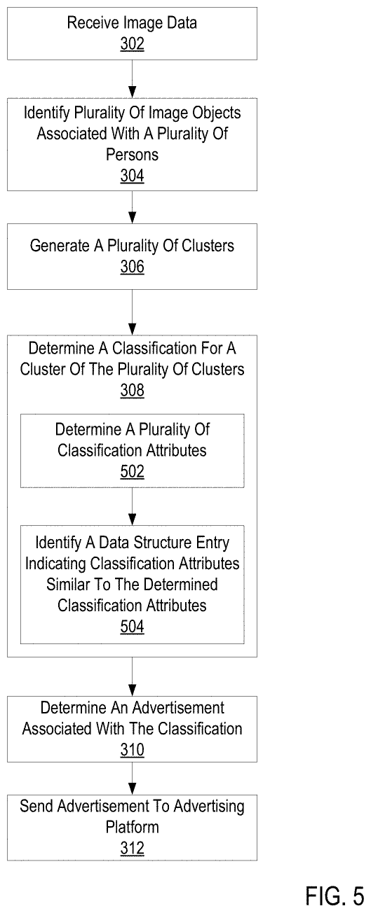

For further explanation, FIG. 5 sets forth a flow chart illustrating an exemplary method for advertisement delivery using audience grouping an image object recognition according to embodiments of the present invention that includes receiving 302 image data; identifying 304 a plurality of image objects associated with a plurality of persons 104; generating 306 a plurality of clusters 110a,b,c; determining 308 a classification for a cluster 110a,b,c of the plurality of clusters 110a,b,c; determining 310 an advertisement associated with the classification; and sending 312 the advertisement to an advertising platform 112.

FIG. 5 differs from FIG. 3 in that determining a classification for a cluster 110a,b,c of the plurality of clusters 110a,b,c may comprise determining 502 a plurality of classification attributes and identifying 504 a data structure entry indicating classification attributes similar to the determined classification attributes. Identifying a data structure entry indicating classification attributes similar to the determined classification attributes may comprise selecting a data structure entry from a plurality of data structure entries each corresponding to a respective classification. For example, the plurality of data structure entries may each indicate a respective plurality of classification attributes. Each data structure entry may also comprise one or more relevant topics for the particular category used for determining 310 an advertisement. Identifying a data structure entry indicating classification attributes similar to the determined classification attributes may comprise selecting, from the plurality of data structure entries, a data structure based on a degree of similarity (e.g., cosine similarity) between the classification attributes of the data structure and the classification attributes of the cluster 110a,b,c.

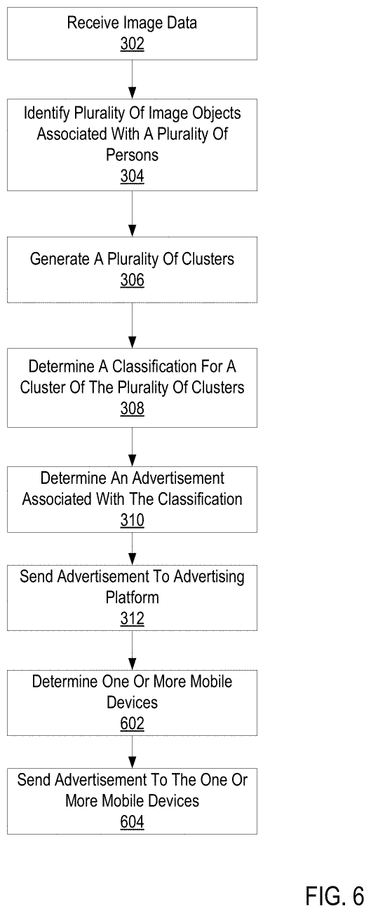

For further explanation, FIG. 6 sets forth a flow chart illustrating an exemplary method for advertisement delivery using audience grouping an image object recognition according to embodiments of the present invention that includes receiving 302 image data; identifying 304 a plurality of image objects associated with a plurality of persons 104; generating 306 a plurality of clusters 110a,b,c; determining 308 a classification for a cluster 110a,b,c of the plurality of clusters 110a,b,c; determining 310 an advertisement associated with the classification; and sending 312 the advertisement to an advertising platform 112.

FIG. 6 differs from FIG. 3 in that the method of FIG. 6 may further include determining 602 (e.g., by the server 604) one or more mobile devices. For example, determining the one or more mobile devices may comprise determining one or more mobile devices proximate to the advertising platform 112 based on a near-field communication link. Determining the one or more mobile devices may comprise determining one or more mobile devices connected to a same network as the advertising platform 112 or connected to a same wireless access point as the advertising platform 112. The method of FIG. 6 may further include sending 604 (e.g., by the server 106) the advertisement to one or more mobile devices. Sending the advertisement to the one or more mobile devices may include sending the advertisement as a push notification, text message, email, or other message. Sending the advertisement to the one or more mobile devices may include embedding the advertisement as a popup or as embedded content in a web page accessed by a mobile device through a wireless network accessible to the server 106.

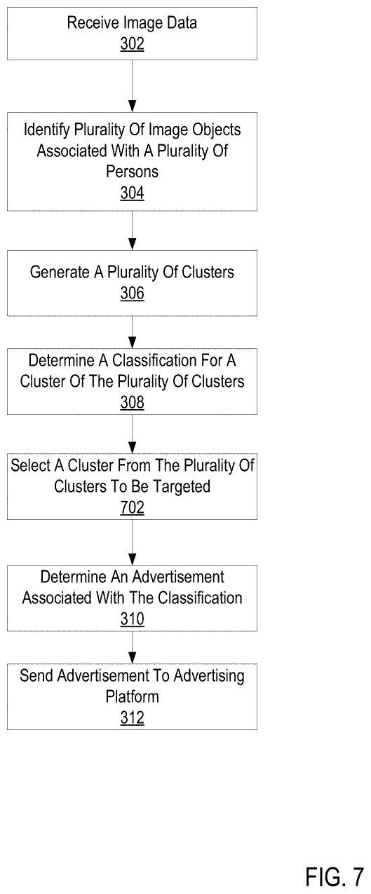

For further explanation, FIG. 7 sets forth a flow chart illustrating an exemplary method for advertisement delivery using audience grouping an image object recognition according to embodiments of the present invention that includes receiving 302 image data; identifying 304 a plurality of image objects associated with a plurality of persons 104; generating 306 a plurality of clusters 110a,b,c; determining 308 a classification for a cluster 110a,b,c of the plurality of clusters 110a,b,c; determining 310 an advertisement associated with the classification; and sending 312 the advertisement to an advertising platform 112.

FIG. 7 differs from FIG. 3 in that the method of FIG. 7 may further include selecting 702 a cluster 110a,b,c from the plurality of clusters 110a,b,c to be targeted. The server 106 may select a cluster 110a,b,c for targeting with an advertisement. Selecting a cluster 110a,b,c may be performed based on a number of persons 104 in the cluster 110a,b,c (e.g, selecting a cluster 110a,b,c with the most persons 104). Selecting a cluster 110a,b,c may also be performed based on a movement speed or detectable facial expression of the persons 104 in the cluster 110a,b,c. For example, a fast-moving cluster 110a,b,c or a cluster 110a,b,c with persons 104 expressing irritation, anger, etc. may be less preferentially selected as the audience may be less receptive to advertisements at that time. Selecting a cluster 110a,b,c may also be performed based on a classification of the cluster 110a,b,c. For example, a classification may correspond to a demographic selected for preferential targeting. A cluster 110a,b,c that was classified into this classification may be preferentially selected.

One skilled in the art would understand that a combination of factors may be used and/or weighted in determining a cluster 110a,b,c for targeting. Additionally, although the flowchart of FIG. 4 shows selecting 702 a cluster after determining 308 a classification for a cluster 110a,b,c, one skilled in the art would appreciate that a cluster 110a,b,c may be selected before or after classification. For example, a cluster 110a,b,c may be selected for targeting before classification based on factors independent of the classification (e.g., a number of persons 104 in the cluster 110a,b,c, a movement direction or speed), and then subsequently classified. This approach saves on computational resources that would otherwise be used to classify clusters 110a,b,c that may not be ultimately selected for targeting.

In view of the explanations set forth above, readers will recognize that the benefits of advertisement delivery using audience grouping an image object recognition according to embodiments of the present invention include:
Being able to select advertisements for delivery to advertising platforms specifically targeted to a particular audience proximate to the advertising platform.
Being able to dynamically update presented advertisements based on the current state of a fluctuating audience.
Feedback allows for dynamic updating in models used for advertisement delivery in order to ensure that the most relevant and/or beneficial advertisements are presented.

Exemplary embodiments of the present invention are described largely in the context of a fully functional computer system for advertisement delivery using audience grouping an image object recognition. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of advertisement delivery using audience grouping and image object recognition, the method comprising:
receiving image data;
identifying, based on the image data, a plurality of image objects associated with a plurality of persons;
generating, from the plurality of persons and based on the plurality of image objects, a plurality of clusters, each of the plurality of clusters comprising one or more persons of the plurality of persons;
determining a classification for a cluster of the plurality of clusters;
determining an advertisement associated with the classification; and
sending the advertisement to an advertising platform based on a location of the cluster.

2. The method of claim 1, wherein the advertising platform comprises a stationary advertising platform.

3. The method of claim 1 further comprising:
receiving feedback associated with the advertisement; and
modifying, based on the feedback, a model associated with one or more of the generating of the plurality of clusters of the determining the classification for the cluster.

4. The method of claim 1, wherein the classification comprises one or more predefined topics of interest, and wherein determining the advertisement associated with the classification comprises determining the advertisement based on the one or more predefined topics of interest.

5. The method of claim 1, wherein determining the classification comprises:
determining, based on one or more image objects of the plurality of image objects associated with the cluster, a first plurality of classification attributes; and
identifying a data structure entry of a plurality of data structure entries based at least in part on a degree of similarity between the first plurality of classification attributes and a second plurality of classification attributes indicated in the data structure entry.

6. The method of claim 1, further comprising:
determining one or more mobile devices; and
sending the advertisement to the one or more mobile devices.

7. The method of claim 1, further comprising selecting the cluster from the plurality of clusters to be targeted by the advertisement based at least in part on one or more of: a number of persons in the cluster, a movement direction of the cluster, or the classification.

8. An apparatus for advertisement delivery using audience grouping and image object recognition, the apparatus comprising a computer processor, a computer memory operatively coupled to the computer processor, the computer memory having disposed within it computer program instructions that, when executed by the computer processor, cause the apparatus to carry out the steps of:
receiving image data;
identifying, based on the image data, a plurality of image objects associated with a plurality of persons;
generating, from the plurality of persons and based on the plurality of image objects, a plurality of clusters, each of the plurality of clusters comprising one or more persons of the plurality of persons;
determining a classification for a cluster of the plurality of clusters;
determining an advertisement associated with the classification; and
sending the advertisement to an advertising platform based on a location of the cluster.

9. The apparatus of claim 8, wherein the advertising platform comprises a stationary advertising platform.

10. The apparatus of claim 8, wherein the steps further comprise:
receiving feedback associated with the advertisement; and
modifying, based on the feedback, a model associated with one or more of the generating of the plurality of clusters of the determining the classification for the cluster.

11. The apparatus of claim 8, wherein the classification comprises one or more predefined topics of interest, and wherein determining the advertisement associated with the classification comprises determining the advertisement based on the one or more predefined topics of interest.

12. The apparatus of claim 8, wherein determining the classification comprises:
determining, based on one or more image objects of the plurality of image objects associated with the cluster, a first plurality of classification attributes; and
identifying a data structure entry of a plurality of data structure entries based at least in part on a degree of similarity between the first plurality of classification attributes and a second plurality of classification attributes indicated in the data structure entry.

13. The apparatus of claim 8, wherein the steps further comprise:
determining one or more mobile devices; and
sending the advertisement to the one or more mobile devices.

14. The apparatus of claim 8, wherein the steps further comprise selecting the cluster from the plurality of clusters to be targeted by the advertisement based at least in part on one or more of: a number of persons in the cluster, a movement direction of the cluster, or the classification.

15. A computer program product for advertisement delivery using audience grouping and image object recognition, the computer program product disposed upon a computer readable medium, the computer program product comprising computer program instructions that, when executed, cause a computer to carry out the steps of:
receiving image data;
identifying, based on the image data, a plurality of image objects associated with a plurality of persons;
generating, from the plurality of persons and based on the plurality of image objects, a plurality of clusters, each of the plurality of clusters comprising one or more persons of the plurality of persons;
determining a classification for a cluster of the plurality of clusters;
determining an advertisement associated with the classification; and
sending the advertisement to an advertising platform based on a location of the cluster.

16. The computer program product of claim 15, wherein the advertising platform comprises a stationary advertising platform.

17. The computer program product of claim 15, wherein the steps further comprise:
receiving feedback associated with the advertisement; and
modifying, based on the feedback, a model associated with one or more of the generating of the plurality of clusters of the determining the classification for the cluster.

18. The computer program product of claim 15, wherein the classification comprises one or more predefined topics of interest, and wherein determining the advertisement associated with the classification comprises determining the advertisement based on the one or more predefined topics of interest.

19. The computer program product of claim 15, wherein determining the classification comprises:
determining, based on one or more image objects of the plurality of image objects associated with the cluster, a first plurality of classification attributes; and
identifying a data structure entry of a plurality of data structure entries based at least in part on a degree of similarity between the first plurality of classification attributes and a second plurality of classification attributes indicated in the data structure entry.

20. The computer program product of claim 15, wherein the steps further comprise:
determining one or more mobile devices; and
sending the advertisement to the one or more mobile devices.
